(19) United States
(12) Patent Application Publication
(10) Pub. No.: US 2007/0163129 A1
(43) Pub. Date: Jul. 19, 2007

(54) DEPTH-OF-CUT GAUGE FOR A POWER SAW

(76) Inventor: Joseph C. Vogelgesang, Kapolei, HI (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/618,638

(22) Filed: Dec. 29, 2006

Related U.S. Application Data
(60) Provisional application No. 60/755,723, filed on Dec. 29, 2005.

(51) Int. Cl. B27B 9/02

(52) U.S. Cl. 30/377

(57) ABSTRACT

A circular saw includes a saw blade for cutting a workpiece. The saw includes a frame; a base plate having a lower surface, the base plate adjustable relative to the frame to achieve a desired depth-of-cut for the saw blade in the workpiece; a lower saw blade guard bias-coupled to the frame, the lower saw blade guard having a closed position and a cutting position relative to the frame; and a plurality of depth-of-cut indications placed on a visible surface of the lower saw blade guard. The lower surface of the base plate is alignable with a desired depth-of-cut indication when the lower saw blade guard is in the closed position.

### CROSS-REFERENCE TO RELATED APPLICATION

This application claims the benefit under 35 U.S.C. § 119(e) of U.S. Provisional Patent Application No. 60/755,723, which is incorporated herein by reference in its entirety.

### BACKGROUND

1. Field of the Invention

This disclosure generally relates to a depth-of-cut gauge for a power saw, such as a portable circular power saw.

2. Description of the Related Art

It is known to provide a depth-of-cut plate positioned as a base plate for a portable circular saw. A depth-of-cut gauge may be marked on a locking guide, such as an indexed slot, slide, or detent stopper on such a portable circular saw. For example, U.S. Pat. No. 6,886,259 to Kani shows a lockable stopper in an arcuate guide slot. U.S. Pat. No. 6,691,418 to Lewin shows a similar locking guide and index slot to that of Kani. U.S. Pat. No. 5,758,425 to Gallagher shows a front-facing index slot and a locking clamp formed in the saw housing. U.S. Pat. Nos. 5,570,511 to Reich; 5,517,763 to Schilling; 5,381,602 to Matzo; and 4,982,501 to Sauerwein show other versions of a front-facing slot and locking clamp formed with the saw housing. U.S. Pat. Nos. 5,454,167 to Albery and 4,856,394 to Clowers and U.S. Patent Publication No. 2005/0155231 to Hartmann show versions of a handle-mounted lock element in a slotted heel. U.S. Pat. No. 4,318,224 to Getts shows a blade depth adjuster for a jigsaw. U.S. Patent Publication No. 2005/0000338 to Wascow shows a transverse mounted depth gauge with adjustable detent positions for nominal thickness values.

With other conventional, portable hand saws, the operator has to manually adjust the saw table or base plate to expose the exact amount of blade depth desired. The operator places the saw on its side, places a ruler on the exposed portion of the blade, which is the portion of the blade extending below the table or base plate, adjusts the table or base plate to provide more or less of the exposed blade portion, then locks the table or base plate at the desired position relative to the saw housing.

### SUMMARY

The embodiments described herein are generally directed to a portable power saw having a depth-of-cut gauge marked on a saw blade safety guard. The saw blade safety guard is circumferentially adjustable relative to a center of rotation of the saw blade. The center of rotation is where the saw blade is rotationally coupled to the portable saw housing and/or frame. The depth-of-cut gauge allows a saw operator to easily measure and then cut into a wood workpiece to a desired depth.

One embodiment of the invention provides indexed depth-of-cut indications that are marked or adhered to a viewable side of a moveable saw blade safety guard. With the saw blade safety guard in a closed position, the operator merely has to move the base plate until an alignment surface of the base plate is visually aligned with one of the indexed depth-of-cut marks and then lock the saw table or base plate in position. To make a cut to the desired depth, the operator simply cuts as normal and lets the moveable saw blade safety guard retract as the cut begins, as is done normally, and urge the saw blade into the workpiece to make the desired depth-of-cut into the workpiece.

In one aspect, a circular saw includes a saw blade for cutting a workpiece. The saw further includes a frame; a base plate having a lower surface, the base plate adjustable relative to the frame to achieve a desired depth-of-cut for the saw blade in the workpiece; a lower saw blade guard bias-coupled to the frame, the lower saw blade guard having a closed position and a cutting position relative to the frame; and a plurality of depth-of-cut indications placed on a visible surface of the lower saw blade guard, and a surface of the base plate is alignable with a desired depth-of-cut indication when the lower saw blade guard is in the closed position.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a side elevational view of a prior art circular saw having depth-of-cut indications on a slotted gauge fixed to the handle, according to one embodiment.

FIG. 2 is a side elevational view of a circular saw having depth-of-cut indication marks placed on a lower saw blade guard, according to one embodiment.

FIG. 3 is a side elevational view of a circular saw of a different design than that of FIG. 2 having depth-of-cut indication marks placed on the lower saw blade guard according to one embodiment.

FIG. 4 is an enlarged view showing the alignment between a base plate and the depth-of-cut marks.

FIG. 5 is an alternative embodiment of aligning with the depth-of-cut marks.

FIG. 6 is an alternative embodiment of the depth-of-cut indication marks.

FIG. 7A is a side elevational view of a decal to be applied to a saw blade guard according to one embodiment of the present invention.

FIG. 7B is a side elevational view of a decal with modified marks according to one embodiment of the present invention.

### DETAILED DESCRIPTION

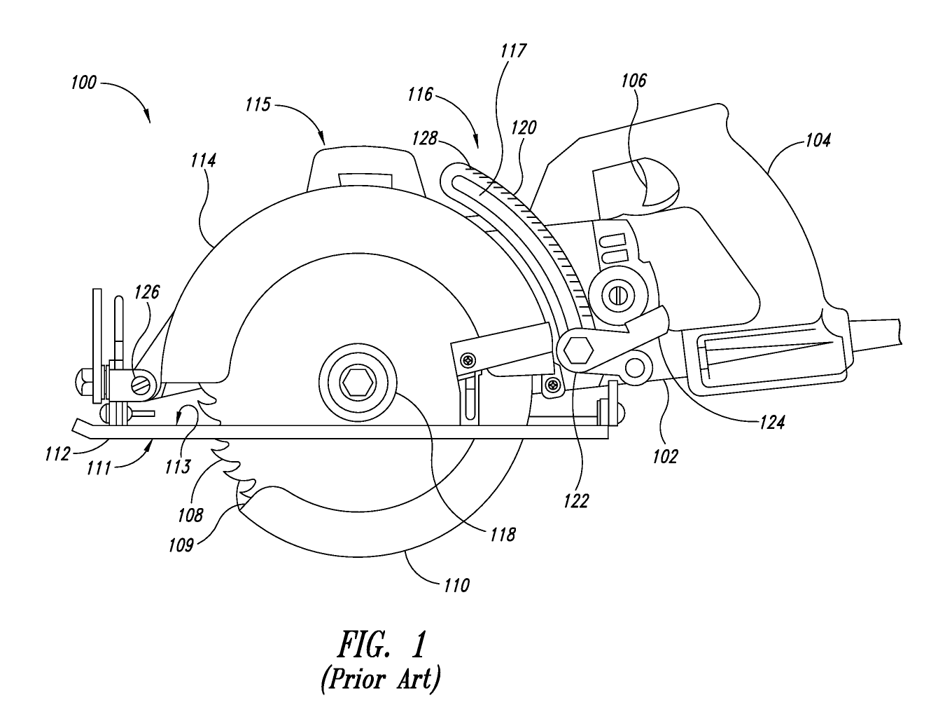

FIG. 1 shows a conventional, portable hand saw 100, which is commonly referred to in the trade as a Skil® saw, but is also generically called a circular saw. (The image shown is based on the prior art Skil® saw model HD77.) The saw includes a frame 102, a handle 104 with a trigger 106, a saw blade 108, a lower saw blade guard 110 having a front edge and a foot or base plate 112. The base plate 112 has a bottom surface 111 and a top surface 113. The saw blade 108 is coupled to the frame 102 at a center of rotation 118 and is driven by motor 115 to rotate relative to the frame 102. The lower saw blade guard 110 is moveable circumferentially about the center of rotation 118, so that as the saw blade 108 is urged into the workpiece, a biasing force to retain the lower saw blade guard 110 in the closed position is overcome to allow the lower saw blade guard 110 to circumferentially rotate about the center of rotation 118 to expose the portion of the saw blade 108 that is located beneath a bottom surface of the base plate 112.

The depth-of-cut adjustment mechanism 116 includes an indexed arcuate locking guard 120 having a slot 117 that engagably receives a pin or bolt 122. The pin 122 moves in the slot 117 to move the base plate 112 relative to the frame 102 and handle 104. (It may also be viewed from the aspect that the base plate 112 is stationary and the motor 115, saw blade 108 and handle 104 move relative to the base plate 112.) A lever 124 is manipulated to allow the arcuate locking guide 120 to be moved relative to the lockable pin 122 by holding the base plate 112 stationary (e.g., with one's foot or hand) and rotating the frame 102, handle 104, and pin 122 relative to the locking guide 120. When the pin 122 is positioned in the locking guide 120 at a desired depth-of-cut mark 128, the lever 124 is tightened to fix the base plate 112 relative to the frame 102 and handle 104. The frame 102, handle 104, and pin 122 rotate relative to the base plate 112 about a first point of rotation 126, which is located near a forward portion of the upper saw blade guard 114. It is understood that as the frame 102, handle 104, and locking guide 120 are moved relative to the first point of rotation 126, the lower saw blade guard 110 also moves relative to the base plate 112.

One disadvantage of the current system is that the index marks 128 do not provide an accurate indication of the true depth-of-cut. The user may fix the base plate relative to the saw tip at what he believes is a known depth-of-cut, for example ½ inch. Unfortunately, because of the mechanical linkages and inaccurate spacing of the relative components, the depth-of-cut may be slightly less than ½ inch so that the piece is not cut through. On the other hand, it may be so much greater than ½ inch that the workpiece is marred and a poor cut is made. As is known in the art, it is desired to have the depth-of-cut exactly match the depth of the wood and be just slightly over so that a clean nice cut is made. If the depth-of-cut is too great, the saw may bind and have kickback. It may also mar the workpiece. Having the exact depth-of-cut is therefore desirable for carpenters working in the art.

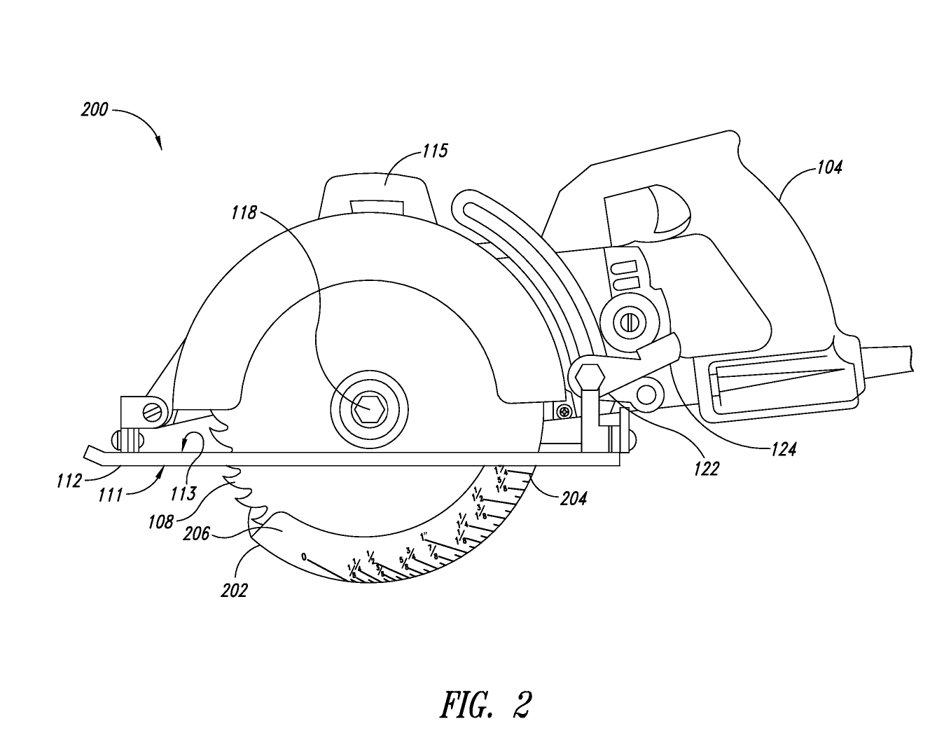

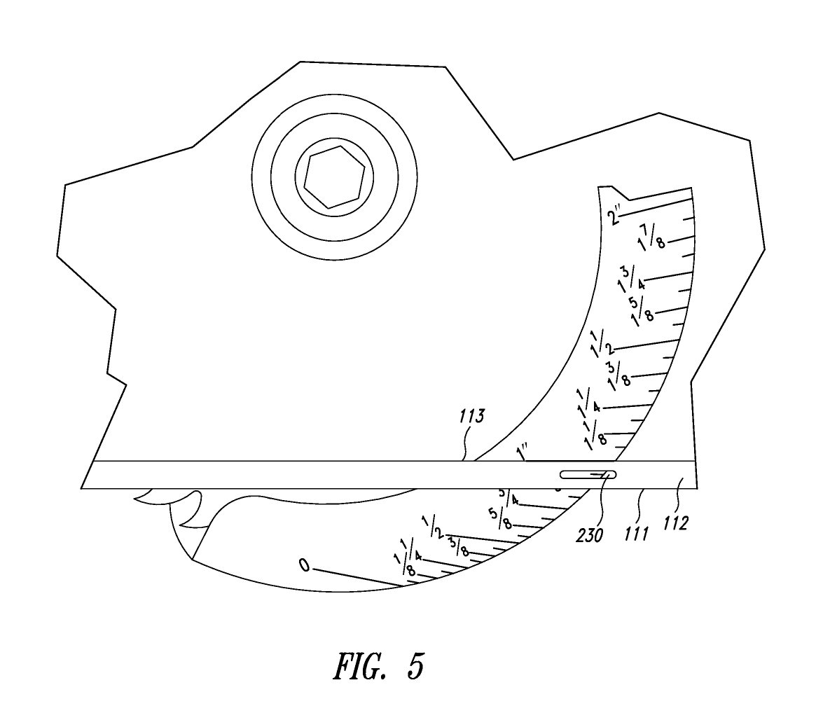

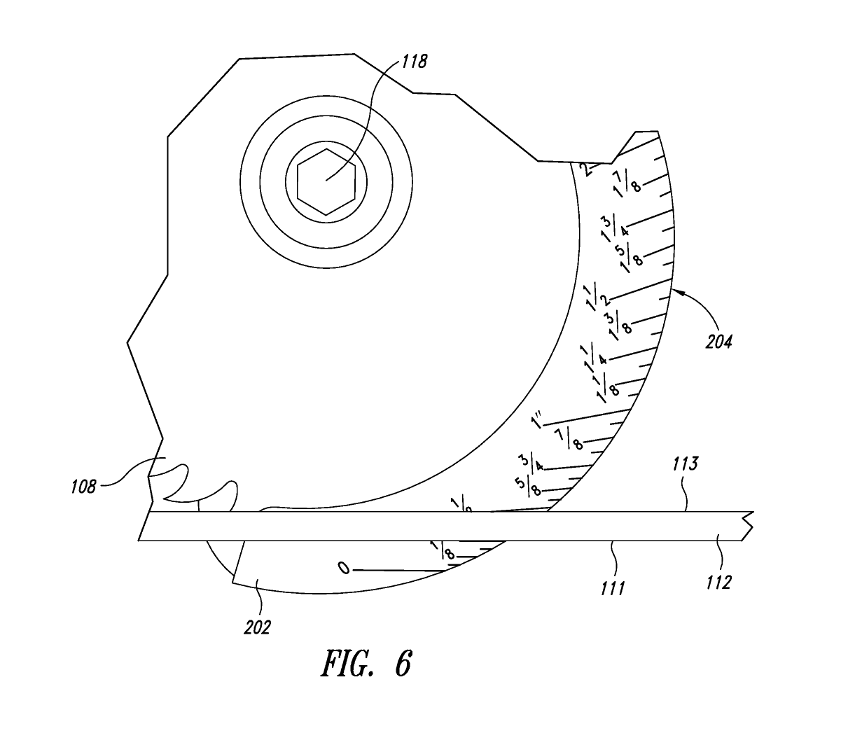

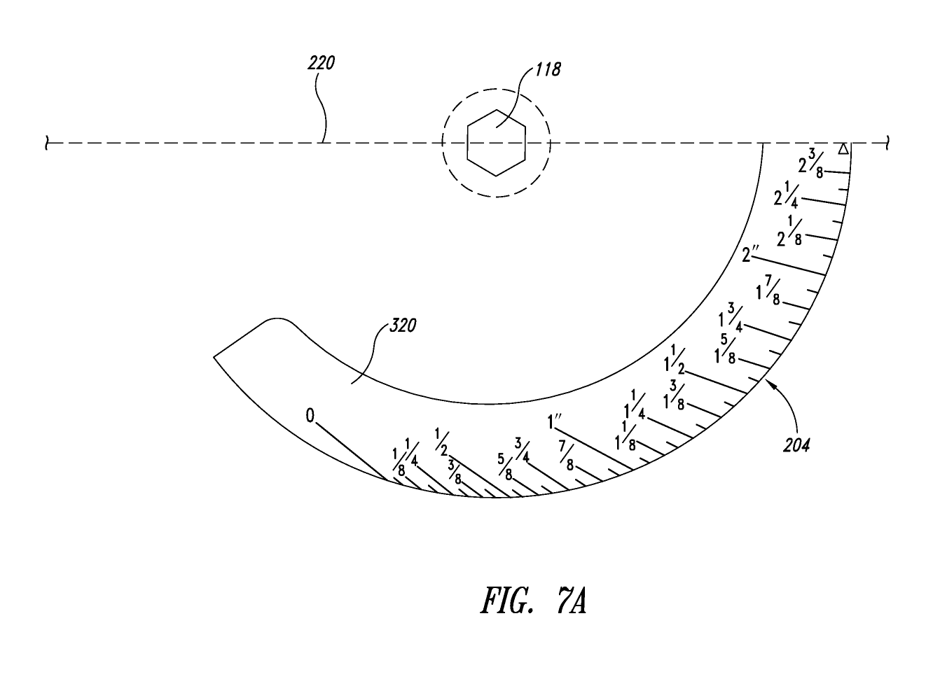

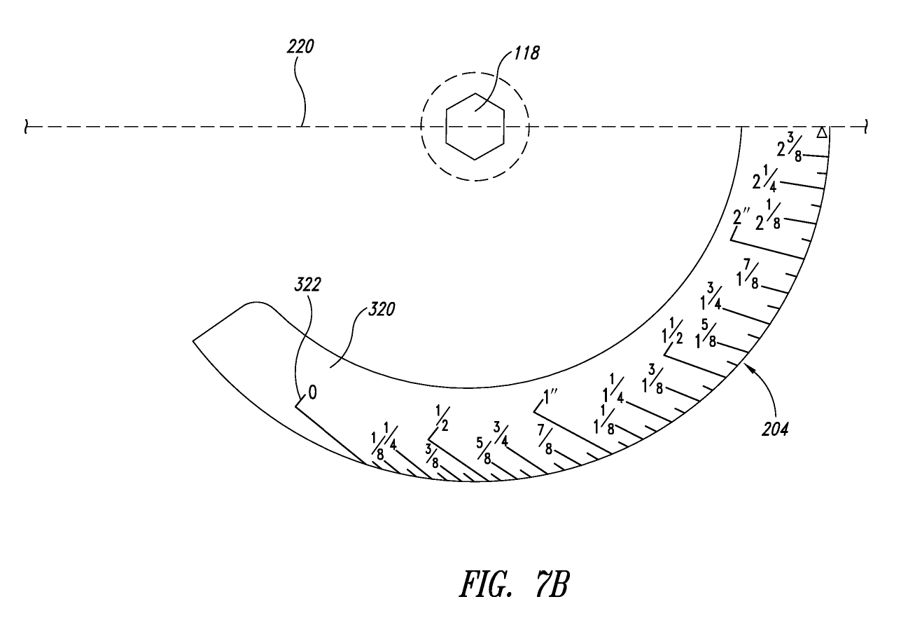

FIG. 2 shows a portable hand saw 200 having a lower saw blade safety guard 202 with indexed depth-of-cut indications 204 marked on a viewable surface 206 of the lower saw blade safety guard 202, according to one embodiment. According to this embodiment, the depth-of-cut indication marks 204 are on the saw blade guard 202 which are directly adjacent to the saw blade 108. Furthermore, the marks 204 are made relative to the rotational axis 118 of the saw blade 108. According to the invention, the depth-of-cut indication marks 204 are made on the saw blade guard 202 which has an angle of curvature that generally matches the saw blade 108. In addition, the angle of the slant of the various indication marks 204 varies to be in alignment with a tangent of the blade 108 at the cutting point for the saw that particular depth of cut corresponding to the location of the mark 204. Accordingly, the depth-of-cut indication marks 204 have a changing slope from a shallow cut, such as 1/16 inch to ⅛ inch, to a deep cut, such as 2 inches or 2½ inches. The respective marks indicate the distance between the bottom of the plate and a tangent to the saw blade that is parallel to the bottom of the plate 112 for cutting at the indicated depth. As will be appreciated, as the base plate 112 is located at different positions, the relative part of the saw blade which is deepest in the material will be slightly different. Viewing for example FIGS. 5 and 6 as compared to FIG. 2 it can be seen that when the plate 112 is at a certain location the bottom of the plate is parallel to the tangent of the line at the cutting point of the saw. The mark which the base plate is aligned with is therefore made parallel to this tangent representing the deepest point of the saw blade during the cut for that particular setting. As the base plate 112 is moved to different locations, the point of the saw's rotations which is the deepest cut will be at a different angular location. The base plate will remain parallel to a tangent of the line which runs through the deepest point of the cut for the saw. Accordingly, the index marks will be at the proper angle so as to be also parallel to the tangent to the deepest point of the cut at that location on the saw blade. The effects of this can be seen by viewing FIGS. 5 and 7A and 7B in which the slope of the indication marks varies so as to always remain parallel to a tangent of the deepest part of the cut for the saw.

When the lever 124 is loosened so that the frame 102, handle 104, and pin 122 can be moved relative to the base plate 112, the lower saw blade safety guard 202 moves relative to the plate 112. Accordingly, the depth-of-cut indications 204 are moved relative to a lower surface 111 of the base plate 112. By aligning the depth-of-cut indications 204 of the lower saw blade safety guard 202 relative to the lower surface 111 of the base plate 112, a more accurate position and depth-of-cut of the saw blade 108 may be achieved than with the prior art.

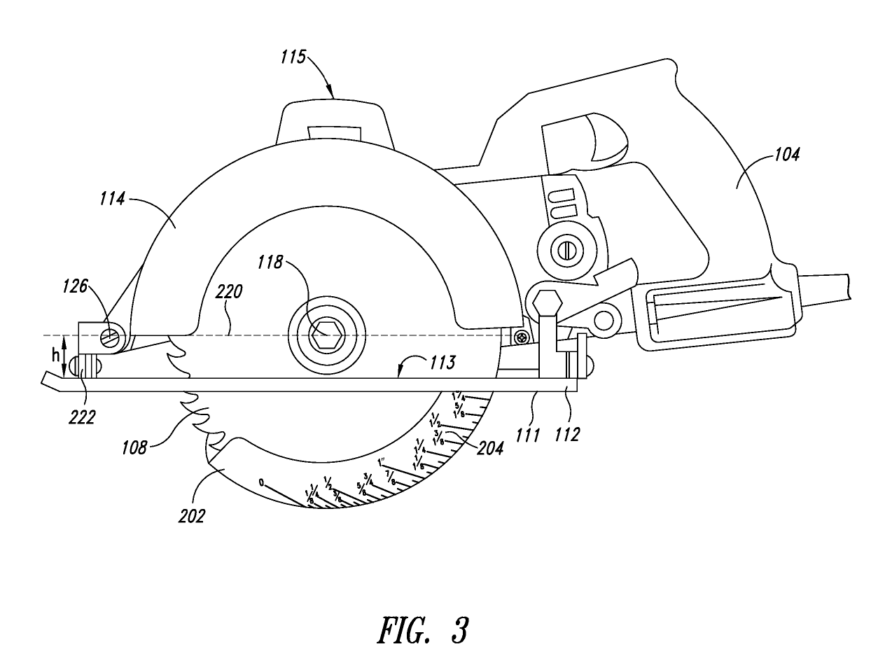

The proper location of the marks is confirmed based on the pivot axis 126 of the base plate 112 and the actual diameter of the blade 108. In many saws, the horizontal line 220 will extend through the pivot axis 126 of the base plate 112 and the rotational axis 118 of the saw blade 108. See, for example, FIGS. 3, 7A and 7B. For saws which are constructed having a horizontal line passing through the axes of rotation 126 and 118 when the base plate 112 is exactly horizontal and parallel to the plane passing through the two axes of rotation, then the depth of cut will base based on the height h of bracket 222 which holds the base plate 112 to the pivot axis 126. In this case, the deepest part of the cut will be a tangent which is parallel to the horizontal plane passing through the rotational axes 126 and 118 as can be seen looking at FIG. 3. Of course, it is not necessary for the saw design to have the axes 126 and 118 in a horizontal plane with respect to each other. According to embodiments of the present invention, the location at which the indication marks 204 are placed on the saw blade guard 202 must take into account the location of the axis 126 about which the base plate 112 rotates as compared to the axis of rotation of the saw blade 118 so as to assure that the marks properly indicate the distance between the bottom 111 of the base plate 112 and the deepest point of the cut of the saw blade 108.

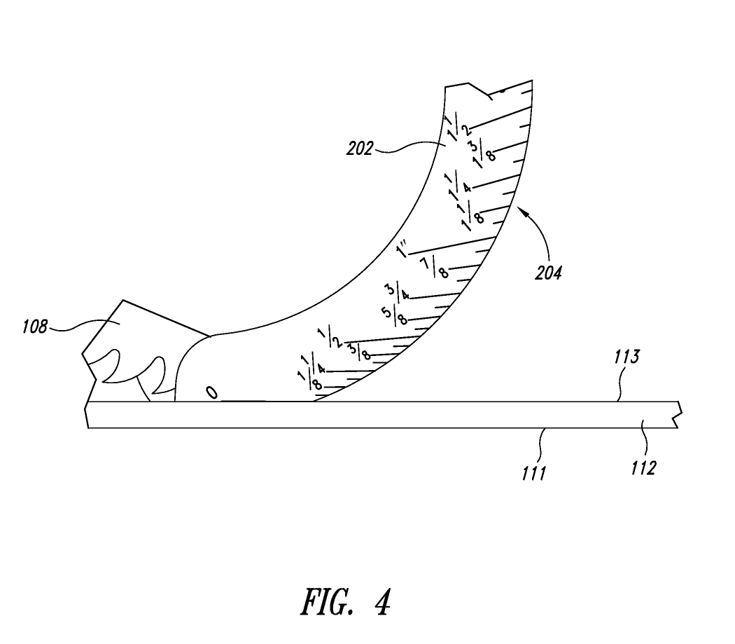

The alignment of the depth mark indications with the base plate 112 can be made according to various alternative designs, some of which are listed in FIGS. 4-6 according to the principles of indicating the correct distance as previously stated herein. As shown in FIG. 4, it is the top 113 of the base plate 112 which is aligned with the mark indicating the correct depth of the cut. As can be seen in FIG. 4, the top 113 is aligned with the zero mark indicating that the depth is set to make no cut at all and to pass over the surface of the work product without being cut even though the saw blade 108 is rotating. If it is desired to make a cut through a material ⅛ inch thick, then the top 113 of the base 112 is set to align with the mark ⅛ based on the embodiment shown in FIG. 4. The blade 108 will extend past the bottom 111 of the base plate 112 in order to cut through a material that is exactly ⅛ inch thick. This means that the distance from the bottom 111 of the base plate 112 to the tip of the blade that is tangent to the bottom of the base plate 112 will be just greater than ⅛ inch so that the material will be cleanly cut without going too far through the workpiece.

The distance that the tip of the saw blade 108 goes through the workpiece can be set according to a desired result. Usually, the tip of the saw blade will extend through the workpiece approximately 1/32 inch so as to cleanly cut the workpiece without going so far through the workpiece as to bind the blade in the cut or to mar the workpiece. In some embodiments and some workpiece products or, depending on the type of teeth in the saw blade, it may be desired to go slightly more through the workpiece, such as 1/16 inch in order to provide the cleanest cut. The indication marks 204 on the saw blade guide 202 are positioned so as to provide a clean cut through workpiece for the given diameter of the saw blade 108 which is connected to the saw. In some embodiments, the depth can be customized to the type of the teeth on the blade 108 as well.

FIG. 5 illustrates an alternative embodiment in which there is a window positioned in the base plate 112 which can align exactly with the mark to indicate the depth of the cut. In this embodiment, an aperture 230 is formed in the base plate 212. The height of the aperture is selected to correspond to the thickness of a mark so that when a mark 204 exactly fills the aperture 230 the worker can be certain that the saw is correctly aligned and will cut at the exact depth as shown. For example, in the embodiment shown in FIG. 5 the depth of the cut is ⅞ inch. The base plate 112 is obscuring the depth measurement of the mark, however, the user knows that when the mark is aligned to the aperture 230 that it is exactly aligned with the proper depth of the cut which is the distance for the indication mark 204 which shows through the aperture window 230.

FIG. 7B indicates one embodiment of the present invention which provides increased visibility and easier alignment with the marks 204 of the plate 112. According to this embodiment, a perpendicular indication 322 is made on the indication marks 204. This mark 322 is at an angle, such as perpendicular or 450 to the main indication mark in order to provide a more easily visible guide for the user to know the exact mark at which his saw is set. As can be appreciated, in some embodiments the base plate 112 may cover up the numerical indication of the depth of cut. Therefore, according to some embodiments it is preferred to move the numerical markings a distance away from the line which they indicate and then provide a perpendicular or other angled line 322 at the end of the mark which is the indication of the depth for the line to which it is attached. In the embodiment of FIG. 7B, such extensions 322 are indicated on each ½ inch of the indication marks 204. These extensions 322 can be provided in the embodiment of FIGS. 2-6 also. Of course, in other embodiments extensions 322 are used on all indication marks or, alternatively only on every-other indication mark so that a user may easily see the depth to which the saw is being set and clearly see all the numbers when the plate 112 is in the proper location for the cut.

FIGS. 7A and 7B illustrate a further alternative embodiment of the present invention. In these embodiments, a decal 320 is provided which can applied to an after-market circular saw by any user. As will be appreciated, the embodiments of FIGS. 2-6 are markings made on the saw blade guard itself by the manufacturer so as to be permanent. Because the diameter of the saw blade 108 which is to be used in a particular saw is known and there are industry standards established for the distance between the axis of rotation 118 and the tip of the blade 108 for a given diameter of saw, it is acceptable in most embodiments to make the markings on the saw guard 202 itself, either with etchings in the metal, permanent raised metal indicia which is colored or other indications which will provide a long-term permanent alignment marks 204 for the user.

FIGS. 7A and 7B illustrate alternative embodiments of providing a user-applied decal which may be used in place of or in addition to the pre-made permanent markings 204 on the saw blade guard 202. According to these embodiments, the decal is provided, having adhesive covered by a protective backing on one side and the indication marks 204 on the other side. The user, taking some care and making the proper measurements will align the decal 320 on the saw blade guide with the correct depth of the cut for a base plate setting. For example, a user may select a ½ inch cut to be made and align the decal so that the alignment mark at the ½ inch indication mark 204 is exactly lined up to indicate the correct distance from the bottom 111 of the base plate 112 to the saw blade tip. After the user is assured of the proper alignment of the decal, he can remove the protective backing, exposing the adhesive and attach the decal to the saw blade guard 202.

The use of a decal 320 has a number of advantages. For already manufactured saws which do not have the indications thereon, the decal can be applied at a later time. The decal can be applied by the manufacturer shortly after manufacture and thus be at a much lower cost than changing the metal etching equipment of the saw blade guard 202. Further, it can be applied by the retail seller prior to the selling of the product in order to provide this additional advantage to the user. Additionally, it could also be applied by the user who attaches it to a saw blade which does not have the depth of gage marking indications on the saw. Many lower priced saws today do not include such depth gage indication markings at all. Namely, the depth indication markings 128 as shown in FIG. 1 are absent on many of the circular saws sold today and the user is left to estimate the proper depth of a cut, often getting it wrong. Using the decal of the embodiments of FIGS. 7A and 7B, the user is able to apply the decal to the saw blade guard 202 and provide an exact depth-of-cut measurement for which previously this was not possible. The saw blade of FIG. 3 has an arrangement such that there is no place that such an indication can be made since the base plate 112 is connected by a different technique to the saw body and there is no location to even place a depth indication gage of the prior art. The present invention advantageously permits such a depth indication gage to be placed on the guard 202. All saws have such a guard 202 since they are required by safety considerations to be present on all circular saws. Accordingly, even a lower-priced saw which has only a few components and a simple wing nut and screw holding the base plate 112 in position will be able to take advantage of the present invention by the application of the decal 320 to the saw blade guard 202.

The invention is used in the following manner. When preparing to make a cut, a user can place the base plate 112 of the saw 200 on a support surface with the saw blade 108 and lower saw blade safety guard 112 hanging over the edge of the support surface and move the base 112 relative to the blade, such as by raising or lowering the frame 102 and handle 104 until the lower surface 111 of base plate 112 is positioned at the desired indication 204 on the lower saw blade safety guard 112.

The base plate 112 is then clamped in position and the cut made by standard techniques. As the blade advances in the cut, the guard 202 will be lifted out of the way as it pushes into the workpiece, as is known in the art. (Alternatively, the user may sometimes manually lift the guard 202 to move it out of the way before it hits the workpiece to obtain a cleaner cut.) The guard 202 will be rotated out of the way to be moved as the blade 108 performs the cut. Of course, once it is moved, the alignment marks are no longer in the correct position. However, the location of the base plate 112 does not move. It was set by a screw or bolt when the guard 202 was in its at-rest position, so later movement of the guard 202 during the cut does not affect the depth of the cut.

Aspects can be modified, if necessary, to employ devices, features, and concepts of the various patents, applications and publications to provide yet further embodiments.

Well-known structures and details associated with stationary and portable power saws and various assemblies and methods of using them are not shown or described in detail since they are well understood by those of skill in the art to which this invention pertains.

The invention can be practiced without all of the details described herein. Many equivalent structures and methods to those described herein can be substituted within the spirit and scope of the invention.

These and other changes can be made in light of the above detailed description. In general, in the following claims, the terms used should not be construed to limit the invention to the specific embodiments disclosed in the specification and the claims, but should be construed to include all types of retainer assemblies and/or kits that operate in accordance with the claims. Accordingly, the invention is not limited to this specification, but instead its scope is to be determined entirely by the following claims.

What is claimed is:

1. A circular saw having a saw blade for cutting a workpiece, the saw comprising:
a frame;
a base plate having a lower surface;
an adjustment member coupled to the base plate and the frame such that the base plate is adjustable relative to the frame to vary a depth-of-cut for the saw blade in the workpiece;
a lower saw blade guard coupled to the frame; and
a plurality of depth-of-cut indication marks placed on a visible surface of the lower saw blade guard to indicate a selected distance from the lower surface of the base plate to the tip of the saw blade during a cut.

2. The saw according to claim 1 wherein the indication marks are parallel to a tangent line at the tip of the saw blade at the location corresponding to the deepest part of the cut for the particular depth that is set.

3. The saw according to claim 2, further including extension lines connected to indication marks that are at an angle other than parallel to the tangent of the saw blade tip at the deepest part of the cut.

4. The saw according to claim 3 wherein angle of the extension is perpendicular to the indication mark.

5. The saw according to claim 3, further including:
an aperture in the base plate that is aligned with the indication mark for the proper depth.
